(19) United States
(12) Patent Application Publication
(10) Pub. No.: US 2016/0139495 A1
(43) Pub. Date: May 19, 2016

(54) ADAPTERS FOR ATTACHING ACCESSORIES TO MOBILE ELECTRONIC DEVICES

(71) Applicant: olloclip, LLC, Huntington Beach, CA (US)

(72) Inventors: Patrick D. O'Neill, Huntington Beach, CA (US); Chong Pak, Lakewood, CA (US); Joshua Cantor, Huntington Beach, CA (US); Ryan Nguyen, Fountain Valley, CA (US); Jason Patrick, Long Beach, CA (US); Daniel Arato, Los Angeles, CA (US)

(21) Appl. No.: 14/857,666

(22) Filed: Sep. 17, 2015

Related U.S. Application Data
(60) Provisional application No. 62/052,272, filed on Sep. 18, 2014.

(51) Int. Cl. G03B 17/56; G03B 17/14; G02B 7/14; H04M 1/02; G02B 13/00

(52) U.S. Cl. CPC G03B 17/565; H04M 1/0264; G03B 17/566; G02B 13/001; G02B 7/14; G03B 17/14

(57) ABSTRACT

In some embodiments, an auxiliary optical system comprises an adapter that is either separable from or unitary with a retainer. The adapter permits the retainer to removably attach to a plurality of mobile electronic devices of different sizes. In some embodiments, an auxiliary optical system comprises a mounting component configured to removably attach to a mobile electronic device and to a base which includes a plurality of attachable subcomponent securement members. Each securement member is configured to receive at least one optical element. In some embodiments, an auxiliary optical system comprises a retainer component configured to removably receive an optical element and to removably receive a non-optical component and/or an electronic component.

### RELATED APPLICATIONS

This application claims the priority benefit of U.S. Provisional Patent Application No. 62/052,272, filed on Sep. 18, 2014 and entitled “Adapters for Attaching Accessories to Mobile Electronic Devices,” which is hereby incorporated by reference herein and made part of this specification for all that it discloses.

### BACKGROUND

1. Field

The inventions relate generally to accessories for mobile electronic devices (e.g., mobile telephones, mobile content players, mobile information storage and display devices, electronic pad devices, laptop computers, desktop computers, etc.), and specifically to removable functional components for mobile electronic devices.

2. Description of the Related Art

In recent years, many advances in computer networking and processing technology have made it possible for mobile electronic devices to include cameras that permit users to capture images. In many cases, these images can be stored, processed, and transmitted. However, there are many design constraints on onboard cameras in mobile electronic devices that can limit the weight, size, expense, shape, adjustability, and features provided by the lensing systems of such cameras. Consequently, many cameras in mobile electronic devices are inadequate for certain photographic needs. These deficiencies cannot be addressed by existing modular or detachable lensing systems for use with conventional film or digital cameras due to significant differences between such lensing systems and wide variability in mobile electronic devices, including incompatibilities in attachment structures, weight, optics, size, transportation, storage, ergonomics, and/or portability.

### SUMMARY

In some embodiments, an auxiliary optical system comprises an adapter that is either separable from or unitary with a retainer. The adapter permits the retainer to removably attach to a plurality of mobile electronic devices of different sizes. In some embodiments, an auxiliary optical system comprises a mounting component configured to removably attach to a mobile electronic device and to a base which includes a plurality of attachable subcomponent securement members. Each securement member is configured to receive at least one optical element. In some embodiments, an auxiliary optical system comprises a retainer component configured to removably receive an optical element and to removably receive a non-optical component and/or an electronic component.

### BRIEF DESCRIPTION OF THE DRAWINGS

Certain embodiments of the inventions will now be discussed in detail with reference to the following figures. These figures are provided for illustrative purposes only, and the inventions are not limited to the subject matter illustrated in the figures. For example, the labels and descriptions in text in the drawings are examples only and should not be understood to limit the usage, materials, function, applicability, or any other aspect of the inventions disclosed herein; rather, such labels and descriptions should be viewed as disclosing some examples or embodiments of a broader genus of structures and features that may or may not include the specific attributes set forth in text in the drawings.

FIG. 1 illustrates an example of a large mobile electronic device and a removable optical device.

FIG. 2A illustrates a front perspective view of the optical device of FIG. 1 being attached to a smaller mobile electronic device.

FIG. 2B illustrates the optical device of FIG. 1 attached to the smaller mobile electronic device.

FIG. 2C illustrates a front plan view of the optical device of FIG. 1.

FIG. 3A illustrates an upper perspective view of an example of securement members in a detached position.

FIG. 3B illustrates an upper plan view of the securement members of FIG. 3A being attached together.

FIG. 3C illustrates an upper perspective view of the securement members of FIG. 3A in an attached position.

FIG. 4A illustrates a rear perspective view of a case for a mobile electronic device.

FIG. 4B illustrates an upper perspective view of the securement members of FIG. 3C in the attached position being attached to or configured for attachment to a mobile electronic device using different adapters.

FIG. 4C illustrates a rear perspective view of an example of a mobile electronic device and an adapter and an optical component.

FIG. 5A is a front perspective view of an example of securement members in an attached position, which includes the securement members of FIGS. 3A-3C.

FIG. 5B is an exploded view of the securement members of FIG. 5A.

FIG. 5C is a front perspective view of the securement members of FIG. 5A being attached together.

FIG. 5D illustrates a securement assembly comprising the securement members of FIG. 5A and an optical component comprising optical subcomponents.

FIG. 5E illustrates the securement assembly of FIG. 5D being attached and in an attachment position on an example of a mobile electronic device.

FIG. 6A illustrates a front perspective view of an example of an adapter used to attach external accessories to a mounting component

FIG. 6B illustrates a front perspective view of an example of a mounting component attached to an external accessory by way of the adapter of FIG. 6A.

FIG. 6C illustrates a front perspective view of another example of a mounting component attached to another external accessory by way of the adapter of FIG. 6A.

FIG. 7A illustrates a front perspective view of an example of a mounting component with an integrated accessory attachment region.

FIG. 7B illustrates a front plan view of the mounting component of FIG. 7A.

FIG. 7C illustrates a front perspective view of the mounting component of FIG. 7A being attached to an accessory,

FIG. 7D illustrates a front perspective view of the mounting component of FIG. 7A attached to an accessory.

FIG. 7E illustrates a front perspective view of the mounting component of FIG. 7A attached to the accessory of FIG. 7C.

### DETAILED DESCRIPTION OF EMBODIMENTS

The following detailed description is directed to certain specific examples of embodiments of the disclosure. In this description, reference is made to the drawings wherein like parts are designated with like numerals throughout the description and the drawings. The inventions are not limited to the examples expressly illustrated or described in this specification, Any step, feature, and/or structure illustrated or described in any embodiment of this specification can be used with or used in place of any other step, function, and/or structure illustrated or described in this specification.

The term “lens” in this specification is used in its ordinary sense, and includes powered lenses (e.g., lenses that focus, magnify, enlarge, or otherwise alter the direction of light passing through the lens), plano lenses (e.g., lenses that are generally planar, lenses that do not taper in thickness, and/or lenses that are not powered), simple lenses, compound lenses, generally spherical lenses, generally toroidal lenses, generally cylindrical lenses, etc. Any imaging device described or illustrated in this specification can include a retainer attached to or attachable to one or more lenses or optical regions with one or more different features, including but not limited to a constant or variable magnifying lens, a wide-angle lens, a fish-eye lens, a telescopic lens, a macro lens, a constant or variable polarizing lens, an anti-reflection lens, a contrast-enhancing lens, a light-attenuating lens, a colored lens, or any combination of the foregoing, etc.

The terms “mobile electronic device” and “mobile device” in this specification are used in their ordinary sense, and include mobile telephones, mobile texting devices, media players, electronic tablet devices, laptop computers, desktop computers, gaming devices, wearable electronic devices (e.g., “smart watches” or “smart eyewear”), and/or mobile electronic communication devices capable of linking electronically to another device or to a network such as the Internet, etc. Some mobile electronic devices include one or more onboard cameras that can be used for various imaging purposes, such as photography and video recording. In addition, some mobile electronic devices include one or more illumination components, such as one or more lights, and/or flashes, etc., that can be used for photography, videography, and/or other purposes (e.g., as a flash light).

Users of mobile electronic devices can capture images and/or video using the onboard cameras of the mobile electronic devices. However, there are many design constraints on such onboard cameras that can limit the weight, size, expense, shape, adjustability, and features provided by the lensing systems of such cameras. For example, existing auxiliary lensing systems for mobile electronic devices may not be compatible with certain mobile electronic devices or certain features of some mobile electronic devices. In addition, users of mobile electronic devices may use other accessories, such as external microphone and/or flash components in addition to existing auxiliary lensing systems. Existing auxiliary lensing systems may not be compatible with the use of such accessories, or may not provide for a structure to attach the accessories to the mobile electronic device. As another example, the mobile electronic devices can vary in thickness, height, width, surface area size or overall shape. Existing auxiliary lensing systems for mobile electronic devices such as those for larger tablets may not be compatible with certain other mobile electronic devices, such as smaller mobile phones, due to difference in the size of the device, the location of onboard cameras, etc. As a further example, users may attach accessories other than auxiliary lens to mobile electronic devices. Existing auxiliary lensing systems for mobile electronic devices may not provide adapters to attach other accessories for mobile electronic devices, such as external microphones and/or flash components.

Adapters can be used with optical devices configured to attach to mobile electronic devices and to provide enhanced photographic functionality when using onboard cameras of mobile electronic devices. The adapters can facilitate attachment of a single optical device to multiple (e.g., two or more) different electronic devices, even if the electronic devices have different dimensions, shapes, camera locations, protective covers, etc. The optical devices that are attached using the adapters may include one or more optical elements, such as macro lenses, wide angle lenses, telephoto lenses, fisheye lenses, lens filters (e.g., polarizers, coloring or darkening filters, etc.), and the like. The optical elements can be used to alter or enhance light that is conveyed to an onboard camera of the mobile electronic device. In some embodiments, an optical device may be configured to convey or permit passage of energy (e.g., sound or light) to or from a component in close proximity to an onboard camera lens of a mobile electronic device, such as a flash and/or a microphone.

Additional accessories can be configured to attach to optical devices. For example, an optical device may be attached to a mobile electronic device. The optical device may include an accessory attachment region or component that allows attachment of an accessory, such as a microphone and/or a flash component. In some embodiments, the accessory can be attached to the optical device rather than directly to the mobile electronic device. Optical devices can facilitate the use of various accessories that may not otherwise be used (or which may not be easily used) with mobile electronic devices.

### Multi-Device Adapter

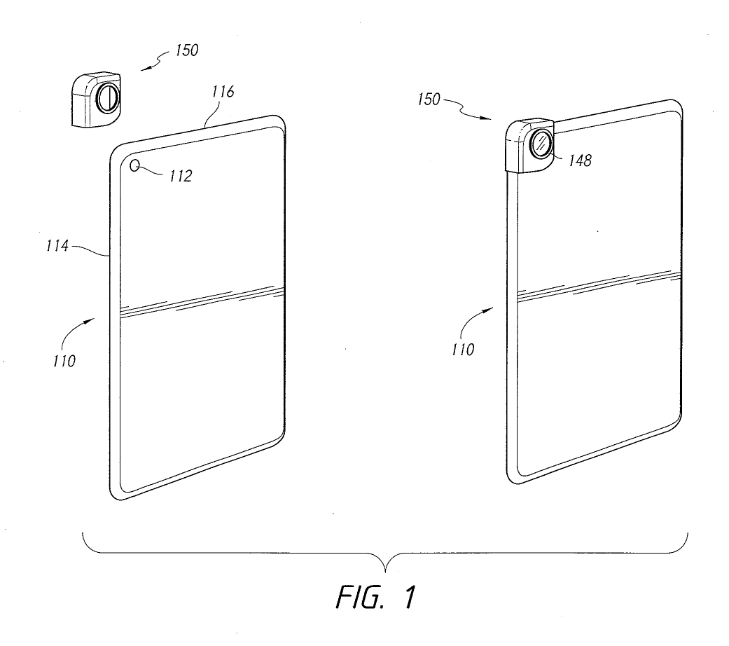

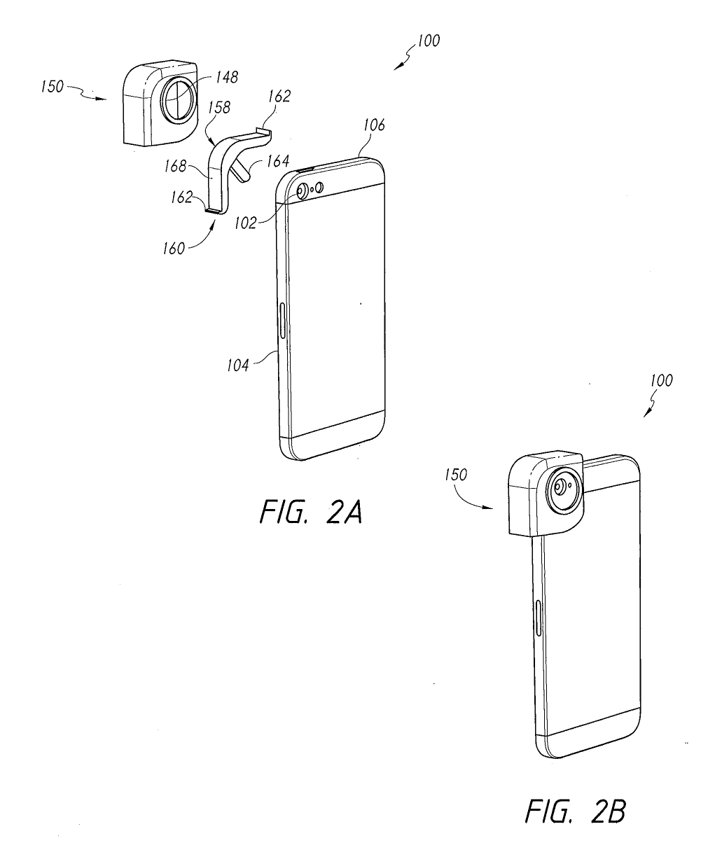

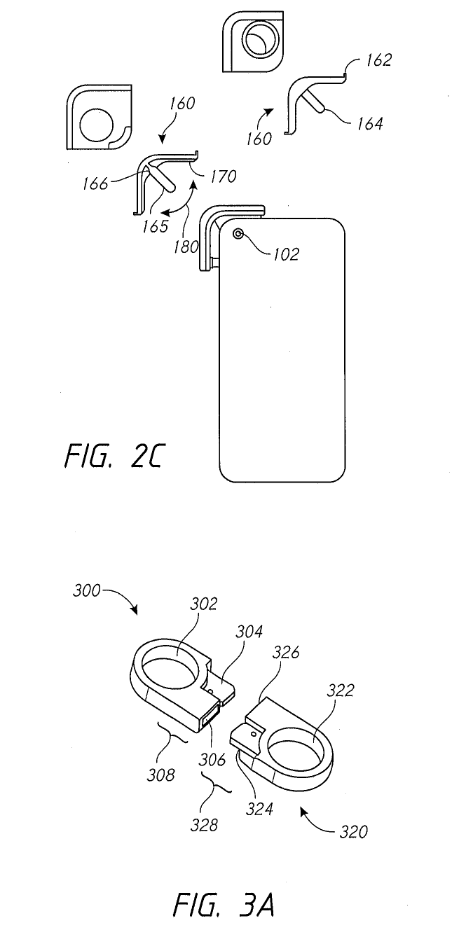

As illustrated in FIGS. 1 and 2A-2C, a mounting component 150 can be removably attached to a larger mobile electronic device 110, or a smaller mobile electronic device 100 in any suitable way, such as by using any or all of the features, structures, and/or steps illustrated or described in U.S. Pat. No. 8,279,544, which is incorporated by reference herein and made a part of this specification for all that it discloses. For example, the mounting component 150 can slide or move onto a corner or onto any other portion of a mobile electronic device 100, 110, such that the mounting component 150 is configured to receive a portion of the mobile electronic device within it. In some embodiments, the mounting component 150 can be temporarily securely retained on the mobile electronic device 100, 110 by way of a friction fit or a clamping structure or any other suitable temporary attachment, such that the mounting component 150 resists sliding or rocking or inadvertent removal. Any feature, structure, step, function, material, and/or component that is described and/or illustrated in the '544 patent can be used with or instead of any feature, structure, step, function, material, and/or component that is described and/or illustrated in this specification. In some embodiments, as illustrated, the mounting component 150 is configured to contact less than an entire edge of the mobile electronic device 100, 110 when attached; and in some embodiments, the mounting component 150 can be configured to contact any portion or portions of the mobile electronic device 100, 110. The mounting component 150 can be a protective or ornamental case, or an integral or removable part of a protective or ornamental case, that protects, receives, envelopes, covers, and/or surrounds all or a part of the mobile electronic device 100, 110.

The mounting component 150 can be used for mounting optical elements, such as lenses, lens filters, and the like to a mobile electronic device 100 or 110 for use with an onboard camera lens 102 or 112 of the respective mobile electronic device. For example, as illustrated, the mounting component 150 can have a lens mounting portion 148 configured to receive optical elements, and the mounting component 150 and align an optical element with an onboard camera lens 102, 112 of the mobile electronic device such the optical elements may convey light to the onboard camera. The mounting component 150 may be configured to clip or attached onto a corner of the mobile electronic device 100, 110 such that mounting component 150 contacts at least two generally orthogonal sides 104 and 106, or 114 and 116, of the mobile electronic device 100, 110. In some embodiments, the mounting component 150 can comprise an assembled or a unitary housing comprising one or more of: a first sidewall configured to contact, or to be positioned adjacent to, a face of a mobile electronic device 100, 110 with an onboard camera 102, 112; a second sidewall generally opposite from the first sidewall and configured to contact, or to be positioned adjacent to, a face of a mobile electronic device 100 with a display screen visible to a user of the mobile electronic device 100; and an upper side or wall that extends between the first and second sidewalls, the upper wall configured to be positioned along (in contact with or adjacent to) an upper edge 106, 116 of a mobile electronic device 100, 110 and a first lateral side edge 104, 114 of the mobile electronic device. As illustrated, any or all of the first sidewall, the second sidewall, and/or the upper wall can extend less than the entire distance across the corresponding edge of the mobile electronic device. In this way, the amount of the device's display that is obstructed by the mounting component 150 may be reduced or minimized. Some examples of mounting components are disclosed and/or illustrated in U.S. Pat. No. 8,279,544. Any feature, structure, step, function, material, and/or component of any of such mounting components can be used with or instead of any feature, structure, step, function, material, and/or component that is described and/or illustrated in this specification,

The mounting component 150 shown in FIGS. 1 and 2A-2C may be large enough or may otherwise be configured to securely removably attach to a first device, such as the larger mobile electronic device 110 shown in FIG. 1 (e.g., attach directly to the device 110 without the use of an adapter or some other component). However, because the mounting component 150 is large enough to attach to the large mobile electronic device 110, it is possible that the mounting component may not securely attach to a different, smaller mobile electronic device 100 due to, e.g., the smaller thickness of the smaller device 100, the different shape of the smaller device 100, etc. In some cases, such as when the different devices 100 and 110 have the same thickness, the mounting component 150 may nevertheless fail to correctly align an optical element with an onboard camera lens 102 of the smaller device 110 due to the different dimensions of the smaller device 110 in comparison with the larger device 100, a different location of the onboard camera lens 102 on the smaller device 100 in comparison with the location of the onboard camera lens 112 on the larger device 110, etc. In some embodiments, a multi-component adapter can be used to facilitate attachment of a mounting component 150 to a plurality of different mobile communication devices, such as both a large mobile device and a small mobile device and to automatically (e.g., without deliberate manual user adjustment) align an optical element that is coupled to the mounting component 150 with an onboard camera lens of both mobile devices.

In some embodiments, as illustrated, a multi-component adapter 160 can comprise a movable (e.g., pivotable or slidable) spacing member 164 and a base or grip portion 158 to enable the multi-component adapter 160 to securely and removably attached to a plurality of different-sized mobile electronic devices. The base or grip portion 158 may include a securement or clip portion 162, an external body surface 168 and an internal body surface 170. The clip portion 162 can protrude in the direction of the external body surface 168 of the adapter 160. In some embodiments, as shown, the spacing member 164 can be an elongated spacing member, such as a lever, that extends from the grip portion 158, As illustrated in FIG. 2C, the spacing member 164 can have multiple (e.g., two or more) portions with different shapes and/or dimensions, such as a thick portion 165 and a tapered portion 166. The tapered portion 166 of the spacing member 164 can be connected or coupled to the internal body surface 170 of the grip portion 158. For example, the tapered portion 166 can attach to a middle of the adapter 160 or be integrally formed with the grip portion 158. In some embodiments, the spacing member 164 can pivot between two positions. For example, as shown, the spacing member 164 can pivot as shown by arrow 180 (e.g., by at least about or less than or equal to about: 30°, 45°or 90°) from a first position to a second position. The spacing member 164 can be made of various materials, such as metal or hard plastic. In some embodiments, the spacing member 164 can be made of rubber, or some other soft or elastic material, such as silicone or some other polymer. In

As illustrated in FIGS. 2A-2C, the adapter 160 can be clipped or otherwise removably attached on to a mounting component 150 to facilitate attachment of the mounting component 150 to a mobile electronic device 100. In some embodiments, such attachment can be secure in that unintended movement such as sliding, rocking, or inadvertent removal can be resisted. For example, a user may install the adapter 160 into the mounting component 150 in order to use the mounting component 150 with a smaller mobile electronic device than would otherwise be possible or practical without the adapter component 160. In some embodiments, as shown, the adapter 160 can contact at least two generally orthogonal sides 104, 106 of the mobile electronic device 100. The external body surface 168 (or some portion thereof) of the adapter 160 can contact an internal surface of the mounting component 150, while the internal body surface 170 (or some portion thereof) of the adapter 160 can contact the mobile electronic device 100.

In some embodiments, the clip portion 162 of the adapter can clamp, grab, clip onto, or otherwise couple to one or more outer edges of the mounting component 150, such as in a friction fit, in order to temporarily secure the adapter 160 to the mounting component 150. The spacing member 164 of the adapter 160 can pivot to contact the internal body surface of the adapter 160. For example, the spacing member 164 can contact either of at least two generally orthogonal sides 104, 106.

The thickness 165 of the spacing member 164 can fill a space 190 between the adapter 160 clipped to the mounting component 150. The adapter 160 can allow a larger mounting component 150 suited for a larger mobile device 110 to be used with a smaller mobile device 100. The spacing member 164 of the adapter 160 can fill a space 190 between the smaller mobile device 100 and the mounting component 150, thereby allowing the mounting component 150 to fit tightly or snuggly and/or securely onto the smaller mobile device 100, such as without manual adjustment. When the adapter 160 with the spacing member 164 is attached to the smaller mobile device 100, the presence of the spacing member 164 can automatically position an optical element (e.g., a lens) that is coupled to the mounting component 150 to be in optical communication with an onboard camera 102 of the smaller mobile electronic device 100.

In some embodiments, the tapered portion 166 can attach to an edge of the adapter 160, such as near the clip portion 162, instead of attaching near the middle of the adapter, as shown. In some embodiments, the spacing member 164 may be detachable. In some embodiments, many other types of materials and/or structures can be used to change the size and/or shape of the attachment mechanism of the internal body surface 170 in order for the mounting component 150 to be configured to securely attach to multiple types of mobile communication devices, such as one or more temporary inserts, adhesives, and/or fasteners, such as Velcro, any of which can be used instead of or in addition to a spacing member 164.

### Optical Element Securement Members

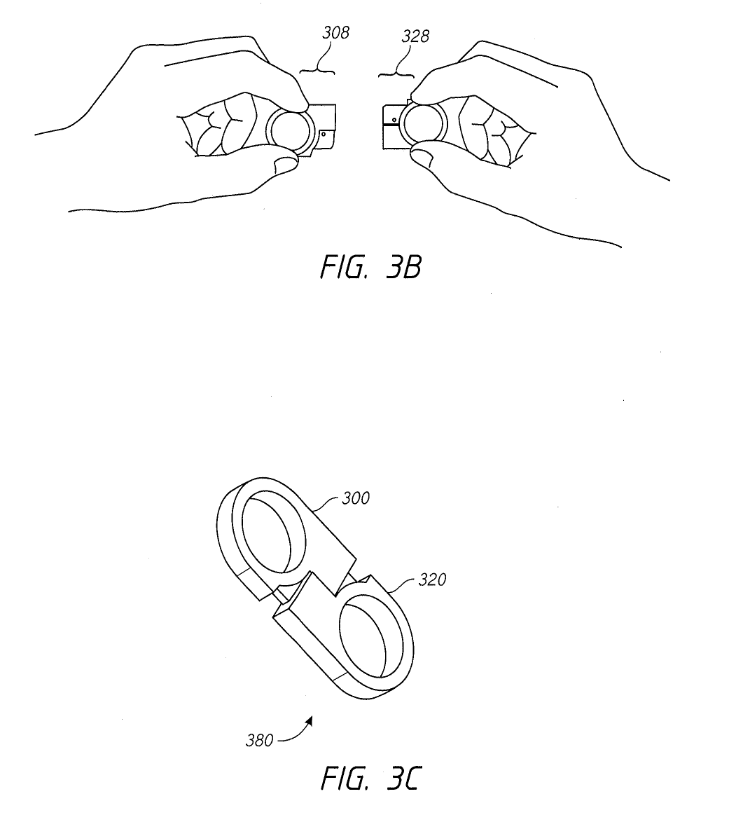

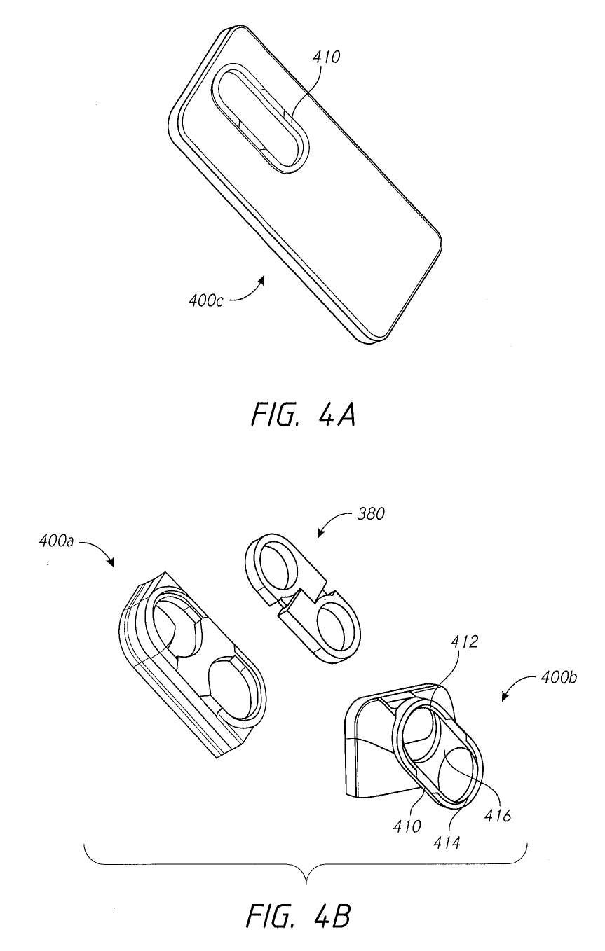

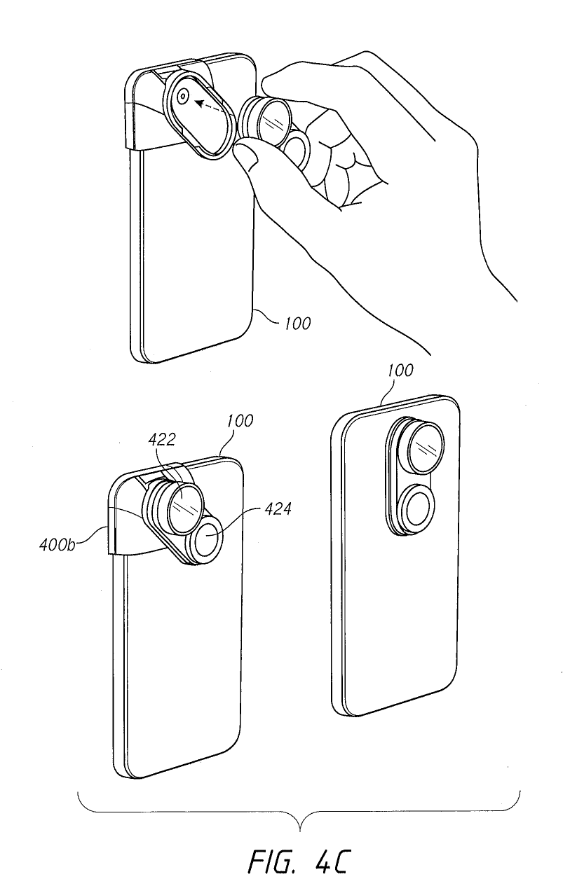

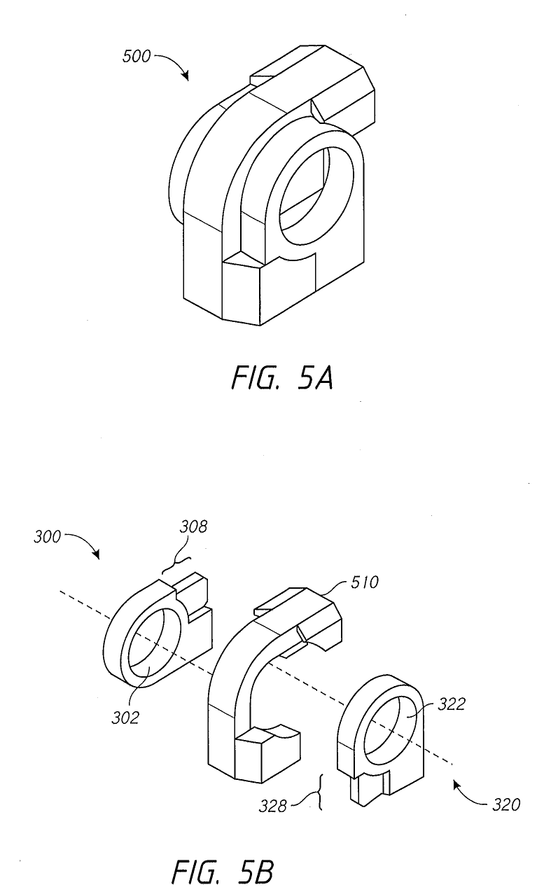

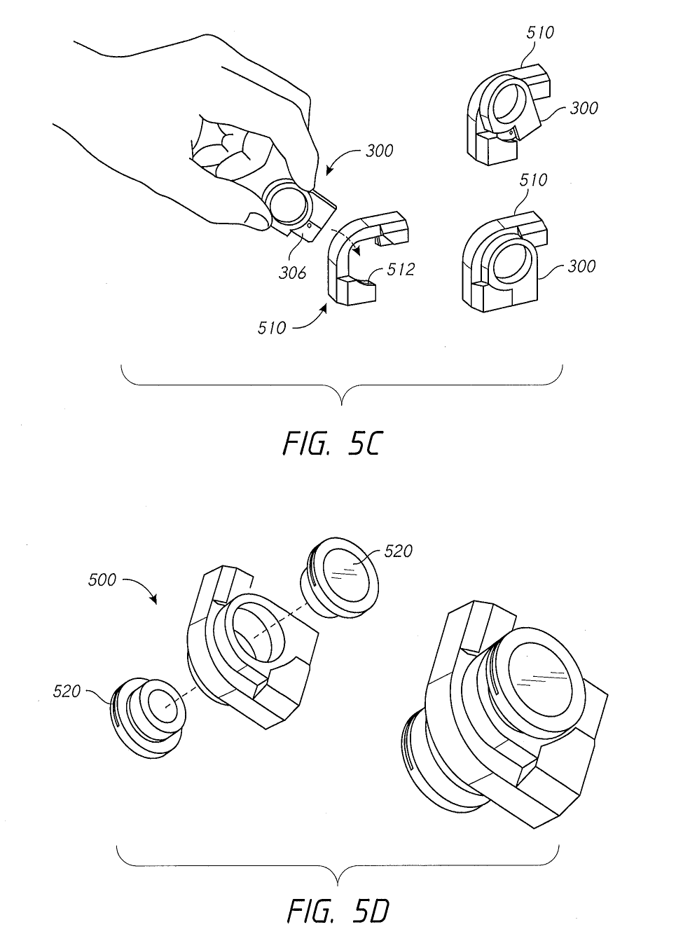

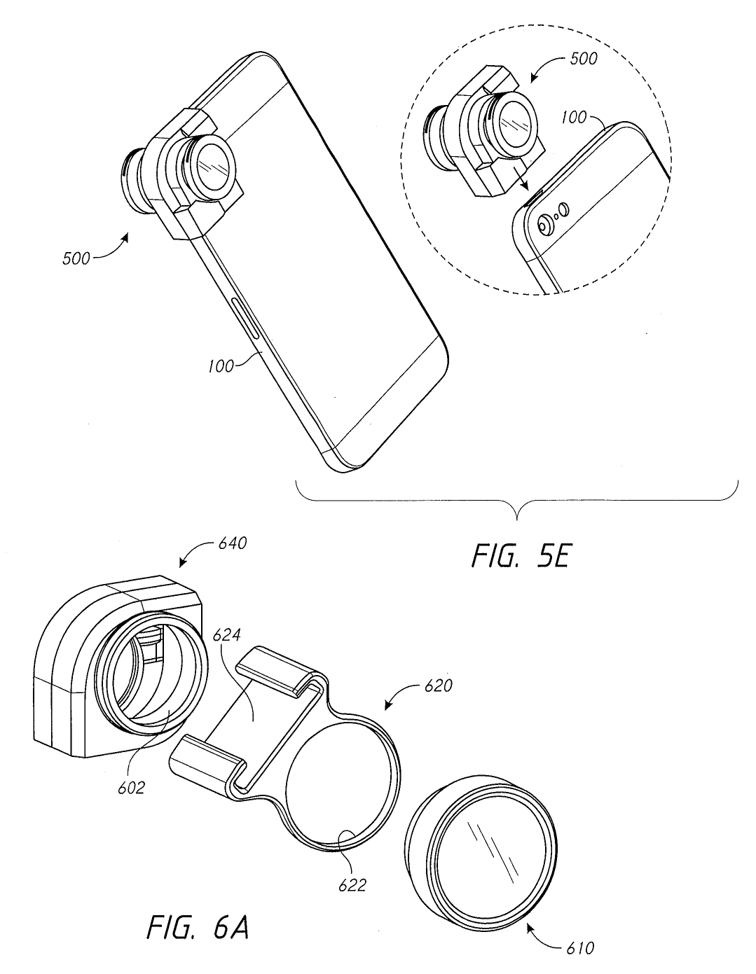

FIGS. 3A-3C show an embodiment of a base or multi-lens component 380 that includes multiple (e.g., two or more) securement members 300, 320 configured to accept optical elements and align the optical elements for use with onboard camera lenses of mobile electronic devices. In some embodiments, as illustrated, each of the securement members 300, 320 are about the same size such that each of the securement members forms about half of the mass of the multi-lens component 380. Each of the securement members 300, 320 can be configured, as shown, to receive a lens or optical element and to removably attach to another securement member 300, 320. The multi-lens component 380 and/or individual securement members 300, 320 may be used with various mounting portions, clips, and/or adapters, such as those shown in FIGS. 4A-4C and 5A-5E, to facilitate user-removable attachment of optical elements to a mobile device, and alignment of the optical elements with an onboard camera lens of the mobile device.

As shown in FIGS. 3A-3C, the securement members 300, 320 can be coupled to one another to form a single, integral multi-lens component 380. The securement members can be used individually or in coupled form on various mounts, on various devices, etc. In some embodiments, a first securement member 300 can include an optical mounting region 302 to which one or more optical elements may be coupled, and an engagement portion 308 to facilitate coupling of the securement member 300 to another securement member, an adapter, a mounting component, or the like. In some embodiments, the engagement portion 308 may include an insertion member 304 and a receiving portion 306. For example, the insertion member 304 may be or include a protrusion, such as a tab or oblong wafer, extending away from the optical mounting region 302. The receiving portion 306 may be configured with a recess to receive an insertion member of another securement member.

Any of the features or structures of the first securement member 300 can be used with or instead of any of the features of the second securement member 320. For example, the second securement member 320 may have an optical mounting region 322 and an engagement portion 328. The engagement portion 328 may include an insertion member 324 and a receiving member 326. In some embodiments, the first securement member 300 and the second securement member 320 are not identical.

In some embodiments, as shown, the first securement member 300 can be coupled to the second securement member 320 to form a multi-lens component 380, which can be used with mobile devices through the use of various adapters and mounting components as described below. For example, the engagement portion 308 of the first securement member 300 can attach to the engagement portion 328 of the second securement member 320 via insertion of the insertion member 304 of the first securement member 300 into the receiving portion 326 of the second securement member 320 and/or by insertion of the insertion member 324 of the second securement member 320 into the receiving portion 306 of the first securement member 300.

FIGS. 4A-4C illustrate various embodiments of mounting components 400a, 400b, 400c that can be used with the securement members of FIGS. 3A-3C. For example, a mounting component 400a can be configured to house a multi-lens component 380 and facilitate use of the multi-lens component 380 with a mobile device 100. The mounting component 400a can be configured to be removably attached to the mobile electronic device 100, registering or contacting on one or more sides (e.g., on two generally orthogonal sides of the mobile device 100) to automatically (e.g., without deliberate manual alignment) position one or more optical elements of the multi-lens component 380 for use with an onboard camera lens 102. In some embodiments, the mounting component 400a may be attached to the mobile device 100 via a friction fit, such that mounting component 400a grasps onto a portion of the mobile electronic device 100 in a manner that resists sliding or removal, unless a user applies a force to remove the mounting component 400a. The mounting component 400a can include a receiving portion, such as a channel, groove, or slot, into which a portion of the mobile electronic device 100 (such as a corner of the device) may be inserted and retained.

In some embodiments, as shown, the mounting component 400a can comprise a mounting region 410, such as an elongate recess, that is configured to receive one or more optical devices, such as a multi-lens component 380. The multi-lens component 380 may include multiple securement members 300, 320 as illustrated in FIGS. 3A-3C, In some embodiments, there is only a mounting region 410 on one side of mounting component 400a that is configured to be positioned near the onboard camera lens of the mobile device 100, since positioning optical elements on the other side of the mounting component 400a may unnecessarily add bulk and weight to the auxiliary lens system. In some embodiments, when many lenses are desired, a mounting region 410 can be provided on both sides of the mounting component 400a.

The mounting region 410 can include first and second apertures or seats 412, 414, and a divider 416 positioned between the seats 412, 414. The divider 416 can optically separate the seats 412, 414, can provide strength in the mounting region 410 against twisting or distortion, and/or can provide an abutting surface against which the multi-lens component 380 can be positioned for attachment. In some embodiments, at least a portion of the mounting region 410 can be configured to be positioned generally over, or generally in alignment with, or generally covering, an onboard camera of a mobile electronic device 100 when the mounting component 400a is attached to the mobile electronic device 100. In some embodiments, the onboard camera may be located in a corner region of the mobile electronic device 100. In some embodiments, the onboard camera is located in an upper middle region of the mobile electronic device. Any mounting component described and/or illustrated in this specification can be configured for attachment to a mobile electronic device in any suitable way, such as in any way that is illustrated and/or described in U.S. Pat. No. 8,279,544 for attaching the retainer portion to a mobile communication device, or in any other way. In some embodiments, as illustrated, when the mounting component 400a and the multi-lens component 380 are attached to each other, the two components can function as a single auxiliary optical system such that the mounting component 400a can be attached or detached from the mobile electronic device 100 without attaching or detaching the multi-lens component 380 from the mounting component 400.

Mounting components 400a, 400b, 400c can be configured to securely but removably receive a multi-lens component 380 for altering or enhancing images taken by the onboard camera lens of the mobile electronic device 100. In some embodiments, as shown, the multi-lens component 380 can be configured to snap or otherwise attach into place on a mounting component 400a, 400b, 400c, forming a friction or interference or fit, or any other secure attachment, with one or more recesses in the mounting component 400a, 400b, 400c. In some embodiments, first and second securement members 300, 320 comprising the multi-lens component 380 can be removably attached in place (such as by a snap fit or a friction fit or a slide fit or a clamping action or any other suitable attachment) or be removed from a mounting component 400a, 400b, 400c at the same time. In some embodiments, the first and second securement members 300, 320 can individually attach to or be removed from the mounting component 400a, 400b, 400c, one at a time. In some embodiments, once the multi-lens component 380 is attached to a mounting component 400a, 400b, 400c, the first and second apertures or seats 412, 414 within the mounting region 410 of a mounting component 400a, 400b, 400c can align with optical mounting regions 302, 322 of the first and second securement members 300, 320.

The mounting components 400a, 400b, 400c can have many different sizes, shapes, and/or configurations. For example, a mounting component 400c can be a protective or ornamental case for a mobile electronic device 100, or it can be integrated, either permanently or removably, into the exterior housing of a mobile electronic device 100. In some embodiments, as illustrated, the case can comprise a first face that is configured to cover, entirely or partially, a face of the mobile electronic device 100 that includes an onboard camera, and/or the case can comprise one or more sidewalls that are configured to cover, entirely or partially, one or more sides of the mobile electronic device 100. The case can comprise an optical mounting region 410 that is configured to receive a lens component, such as a multi-lens component 380. In some embodiments, the optical mounting region 410 is positioned in a generally upper central region on the case and/or is oriented in a generally vertical direction, as shown. In some embodiments, at least a portion of the optical mounting region 410 is located in a corner region on the case and/or is oriented in a generally oblique or diagonal direction, neither vertical nor horizontal. The optical mounting region 410 in any embodiment can be generally oblong and/or generally elliptical, with first and second generally curved ends and a generally straight intermediate region. In some embodiments, the optical mounting region 410 can be configured to receive a single-lens component.

In some embodiments, a manufacturer can provide a mounting component 400a, 400b, or 400c and a first multi-lens component 380 to a consumer, and then the manufacturer can instruct a user to attach the mounting component and the multi-lens component to a mobile communication device 100. The first multi-lens component may, at the user's discretion, be removed and replaced with a second multi-lens component (e.g., one providing different optical elements or other desirable features). The first and second multi-lens components can have different optical features, as described elsewhere in this specification. In some embodiments, the user may remove and replace individual securement members 300, 320, or individual optical elements 422, 424 coupled to the securement members 300, 320. In some embodiments, the user may remove and replace one or more optical elements 422, 424 from individual securement members 300, 320, without removing or adjusting the multi-lens component 380.

In some embodiments, as illustrated, the outer periphery of the multi-lens component 380 can generally correspond to or generally match the inner periphery of the mounting region 410 to help provide a secure attachment between the multi-lens component 380 and the mounting component 400a, 400b, or 400c. The outer periphery of the multi-lens component 380 can be slightly larger than the inner periphery of the mounting region 410 to facilitate an interference or friction fit. The multi-lens component 380 can be secured in a non-movable (e.g., non-rotatable, and/or non-slidable, etc.) configuration when attached to a mounting component 400a, 400b, 400c until such time as the multi-lens component 380 is detached or decoupled from the mounting component 400a, 400b, 400c by a user.

The multi-lens component 380 can include one or multiple (e.g., two or more) optical elements designed or configured to enhance or alter light passing through the respective optical element to the onboard camera lens of the mobile electronic device 100 in different ways. In some embodiments, as illustrated, the multi-lens component 380 includes only two lenses or other optical elements in order to diminish the weight and/or bulk of the multi-lens component. Each of the plurality of optical elements can be surrounded, substantially or entirely, by a protective periphery, such as a ring. A plurality of lens elements, as shown, can be effectively coupled to each other in the multi-lens component by joining them along such protective peripheries. As illustrated, in some embodiments, the multi-lens component is configured to receive ambient light that is impinging on the side of the mobile electronic device with the onboard camera. In some embodiments, a suitable single-lens component can be attached to a mounting component 400a, 400b, 400c, Except as otherwise specified, any description of a multi-lens component 380 can also apply to a single-lens component.

In some embodiments, one or more individual lenses or other optical elements of the multi-lens component 380 can be removed from the body of the multi-lens component 380, cleaned, modified, and/or replaced with one or more other individual lenses. In some embodiments, the attachment and detachment of the individual optical elements of the multi-lens component 380 to the body of the multi-lens component 380 can be accomplished by a temporary attachment, such as a screwing motion, a snap-fit, a clip, or any other suitable temporary attachment, or by a permanent attachment, such as adhesive, sonic welding, solvent, or any other suitable permanent attachment.

In some embodiments, as illustrated, the connection between a mounting component 400a, 400b or 400c and the multi-lens component 380 can be performed in a plurality of different positions, locations, and/or orientations. For example, as illustrated, a user may connect a mounting component 400b and the multi-lens component 380 in a first position or orientation to position a first optical element 422 (e.g., a fisheye lens) in general alignment with, or in optical communication with, the onboard camera of the mobile electronic device 100 to take photographs with the mobile electronic device 100. The user may then detach or decouple the multi-lens component 380 from the mounting component 400b, which can be configured to remain in place on the mobile electronic after the multi-lens component 380 is removed, and then the user can change the position of the multi-lens component 380 on the mounting component 400b, such as by rotating, pivoting, or otherwise moving the multi-lens component 380, and then reattaching the multi-lens component 380 to the mounting component 400b in a second position, thereby positioning a different optical element 424 (e.g. a wide angle lens) in general alignment with or in optical communication with the onboard camera lens of the mobile electronic device 100. The first and second optical elements 422, 424 shown and described are illustrative only, and are not intended to be limiting. In some embodiments, a multi-lens component 380 may include other types of optical elements, such as one or more telephoto lenses, macro lenses, polarizing lenses or filters, coloring lenses or filters, anti-glare lenses or filters, and the like, and/or any combinations thereof.

The detachability of the multi-lens component 380 from the mounting components 400a, 400b, 400c can provide certain advantages. For example, a collection of a plurality of small multi-lens components 380 can be provided with or used with optical elements having many different optical characteristics for different photographic needs. Such optical elements can be attached or detached as needed, without requiring all of such different optical elements to be attached to the mobile electronic device at the same time (which would increase the overall weight and size of the auxiliary optical system). In addition, the detachability of the multi-lens component 380 can allow it to be used on a plurality of different mobile electronic devices (e.g., a phone or a pad device, several different phones among friends or family members, etc.) in a quick and easy way, without having to remove or replace the mounting components 400a, 400b, 400c on such devices. In some situations, a mounting component 400c may be integrated into a case for a mobile electronic device. Because the multi-lens component 380 can be removed from one mounting component and attached to another, the case with the integrated mounting component 400c can remain attached to the mobile electronic device 100 for a long period of time, and the multi-lens component 380 can be temporarily attached as needed (e.g., when a user wishes to capture a photographic image).

In some embodiments, a mounting component 400a, 400b, 400c can be configured to allow the user to change the location of the securement members 300, 320 while the securement members are snapped into the mounting portion 410. For example, a securement member 300 can slide or otherwise move within or on the mounting portion 410 along a track. Adjustability of the position of the securement members 300, 320 within the mounting portion 410 may allow one mounting portion to be used with different size mobile devices having different onboard camera locations, such as tablets, mobile phones, and mobile devices from different brands.

In some embodiments, a mounting component 400a, 400b or 400c can include a structure or component configured to facilitate or enhance conveyance of energy or information to and/or from an input and/or output component of the mobile electronic device 100. For example, a mounting component can include a light-conveying component such as a fiber optic or polycarbonate component that facilitates the conveyance of light from a flash on the mobile electronic device 100 to an area generally in front of the mounting component. In some embodiments, a mounting component 400a, 400b or 400c can include an energy conveying path that is generally open and generally unobstructed between a region on the mobile electronic device and a region on the mounting component for assisting in the transmission of energy to or from an input and/or output device on a mobile electronic device while generally preserving the quality of a signal, image, or information being transmitted by such energy. Examples of transmitted energy conveyed to or from mobile electronic devices include electrical impulses, acoustic sound waves, visible light, or other electromagnetic energy.

### Multi-Piece Mounting System

FIGS. 5A-5E show a mounting system 500 that can be used with the securement members described above to facilitate use of various optical elements with a mobile electronic device. As shown, multiple securement members 300, 320 may be coupled to opposing sides of an adapter 510, which can be removably attached to a mobile electronic device in any suitable way, such as by using any of the structures, steps, or methods described and/or illustrated elsewhere in this specification or in U.S. Pat. No. 8,279,544. An optical element coupled to one of the securement members 300 or 320 may be positioned in optical alignment with an onboard camera lens of the mobile device. In addition, the mounting system 500 can be removed, rotated, and re-attached to the mobile electronic device, thereby aligning a different optical element (coupled to a different securement member) with the onboard camera lens of the mobile device. In some embodiments, a mobile device may have multiple onboard camera lenses, such as an onboard camera lens on each of two opposing faces. The adapter 510 may be configured to simultaneously position an optical element in optical alignment with each of the onboard camera lenses of the mobile device (or some subset thereof).

In some embodiments, as shown, the optical mounting system 500 may include first and second securement members 300, 302 and an adapter portion 510. As shown in FIG. 3A and described above, the first and second securement members 300, 320 may include optical mounting regions 302, 322 and engagement portions 308, 328. The adapter portion 510 may include one or more attachment regions 512, such as grooves, configured to accept an engagement portion of a securement member. For example, each attachment region 512 can receive an insertion member 306, 326 for a securement member 300, 320. As shown, a user may couple a securement member 300 to the adapter portion 510 by pivoting or otherwise inserting the insertion member 306 into the attachment region 512 of the adapter portion 510. A second securement member 320 can be coupled to the adapter portion 510 via a second attachment region 512, such as an attachment region 512 on an opposite side of the adapter portion 510. In some embodiments, multiple securement members may be used with a single adapter portion 510.

One or more optical elements 520 can be coupled to the mounting system 500. In some embodiments, optical elements 520 can removably attach (e.g., using threaded screw mounts, bayonet mounts, friction fits, etc.) to the optical mounting regions or some other region of the first and second securement portions 300, 320. The optical elements 520 can be different lens components having different size, aperture, color, effects, etc.

### Adapter for External Accessories

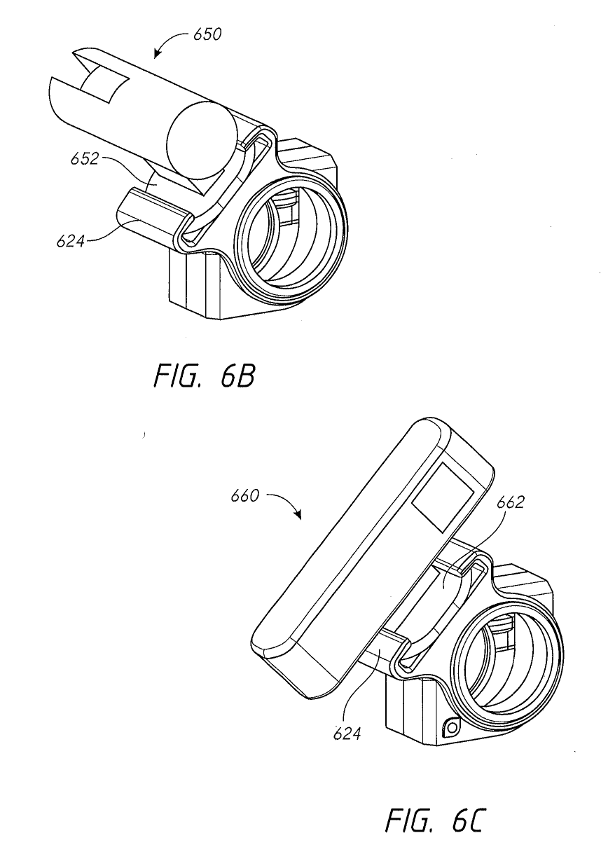

FIG. 6A shows an adapter 620 that can be added to a retainer component 640, which can be removably attached to a mobile electronic device in any way, such as by using any of the structures, steps, or methods illustrated and/or described elsewhere in this specification or in U.S. Pat. No. 8,279,544, to facilitate attachment of accessories to the retainer component 640. The adapter 620 can include an accessory attachment region 624 and a mounting portion 622. The mounting portion 622 can have a shape which can be complementary to an optical mounting region 602 of the retainer component 640. In some embodiments, the accessory attachment region 624 may be a cold-shoe (without electronic capability) or a hot-shoe (with electronic capability). As shown in FIGS. 6B and 6C, the attachment region 624 can be configured to receive or mate to mounting structures 652, 662 of one or a plurality of external accessories 650, 660, such as non-optical accessories. The outer surface of the adapter 620 can be shaped or otherwise configured such that contact with the outer surface of the retainer component 640 position the adapter 620 at a pre-set angle relative to the retainer component 640 without deliberate manual adjustment.

In some embodiments, the adapter 620 can be inserted between an optical element 610 and the retainer component 640, so that the adapter 620 is secured between the lens component 610 and the retainer component 640. The mounting portion 622 of the adapter 620 can be placed over the optical mounting region 602 when the optical element 610 is attached to the retainer component 640. Any optical element described and/or illustrated in this specification can be configured or attached in any way illustrated and/or disclosed herein for attaching optical elements, or in any other way.

The accessory attachment region 624 can mate with or otherwise be attachable to one or more external accessories by, e.g., providing a mechanical and/or electrical connection to an accessory (such as an electronic accessory) having a mating portion, such as a cold or hot shoe. For example, the attachment region 624 can mate removably and securely to a mating portion 652 of a microphone, such as a mini-boom microphone 650. As another example, the accessory attachment region 624 can mate to a mating portion 662 of a flash, such as a mini-flash 660. In some embodiments, the accessory attachment region 624 can provide both mechanical and electrical connections to an accessory, thereby allowing the mobile electronic device to control the accessory via a wired connection (not shown). The accessory can have multiple features, such as a microphone, a speaker, a flash, a flashlight, an indicator, and/or any other auxiliary device.

In some embodiments, the adapter 620 can be placed over the optical element 610 instead of being placed between the optical element 610 and the retainer component 640. The retainer portion 640 can include one or more movable mounting structures (not shown) such as one or more adapters, latches, screws, levers, buttons, or cams, etc., or one or more non-movable mounting structures such as one or more magnets, snaps, hook-and-loop attachments, adhesive tapes, etc. In some embodiments, the adaptor 620 can be appropriately configured to plug or snap or otherwise attach to or into the body of the retainer component 640. An electrical attachment can be configured to removably extend between one or more of the external accessories 650, 600 and a mobile communication device, such as through one or more electrical ports (e.g. a headphone port and/or a charging port) to provide power, communication, and/or control for one or more of the external accessories 650, 600.

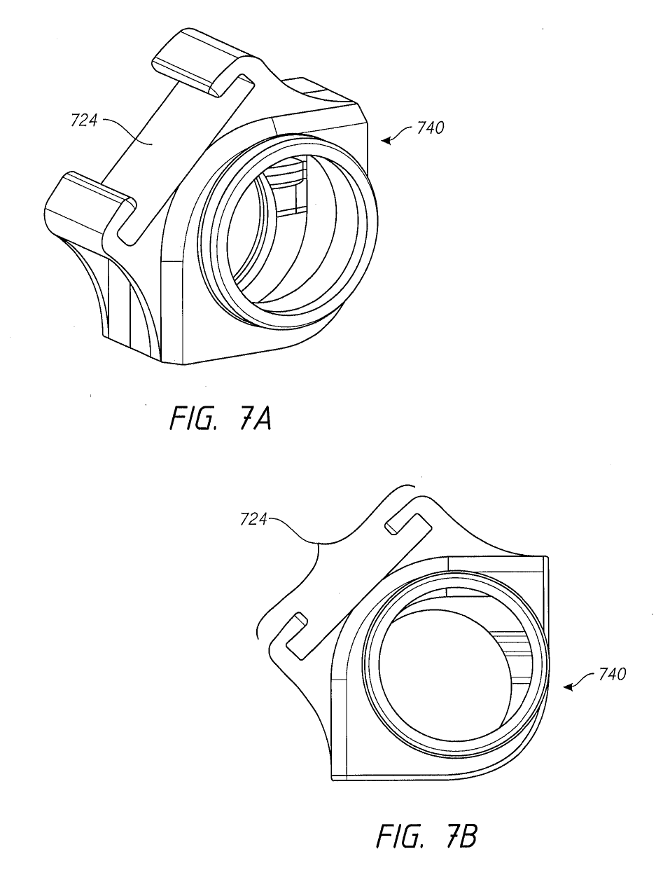

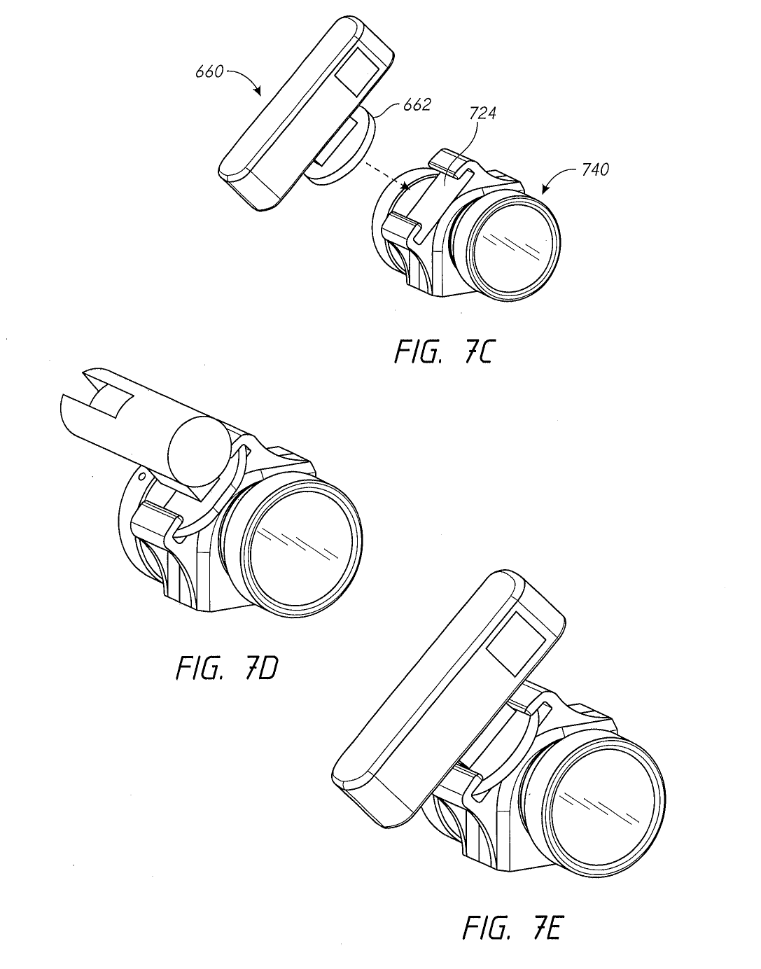

FIGS. 7A-7E show a retainer component 740 with an integrated or unitary accessory attachment region 724. The retainer component 740 can comprise any of the features, structures, steps, and/or materials described and/or illustrated in connection with the retainer component 640 and/or the adapter 620 of FIGS. 6A-6C. The retainer component 740 can mate with any suitable accessory, such as a flash or microphone accessory 660, 650, without the use of a separate adapter 620.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. It is also contemplated that various combinations or subcombinations of any specific features and aspects of any embodiments may be combined with any specific features of any other embodiments, which still fall within the scope of the invention. Accordingly, it should be understood that various features and aspects of the disclosed embodiments can be combined with or substituted for one another in order to form varying modes of the disclosed invention.

The following is claimed:

1. An adapter for using an optical component that is configured to securely and removably attach to both a first mobile electronic device and a second mobile electronic device that is a different size than the first mobile electronic device, the adapter comprising:
a first portion configured to secure the adapter to the optical component; and
a movable spacing member extending from the first portion, the spacing member configured to move between a first position in which the first portion is configured to attach securely and removably to a first mobile electronic device and a second position in which the first portion is configured to attach securely and removably to a second mobile electronic device that is a different size than the first mobile electronic device.

2. The adapter of claim 1 in which the movable spacing member is a lever.

3. The adapter of claim 2 wherein the lever is configured to pivot between the first and second positions.

4. The adapter of claim 3 wherein the adapter is configured to resist sliding or rocking in the first position when attached to the first mobile electronic device and in the second position when attached to the second mobile electronic device.

5. An optical system configured to removably attach to a mobile electronic device, the optical system comprising:
a mounting component configured to securely and removably attach to a mobile electronic device;
a plurality of optical elements;
a base configured to receive the plurality of optical elements, the base comprising a plurality of removably attachable securement members, each removably attachable securement member being configured to receive a separate one of the plurality of optical elements, and the base being configured to securely and removably attach to the mounting component.

6. The optical system of claim 5 wherein each of the securement members are about the same size.

7. The optical system of claim 5 wherein the plurality of optical elements have different optical features.

8. The optical system of claim 7 wherein the plurality of optical elements comprises a plurality of lenses.

9. The optical system of claim 8 wherein the base is attachable to the mounting component by way of a snap fit.

10. The optical system of claim 9 wherein the mounting component is configured to removably and securely attach to a corner portion of a mobile electronic device.

11. optical system of claim 9 wherein the mounting component is configured to removably and securely attach to a central region of a mobile electronic device.

12. The optical system of claim 9 wherein the mounting component is a case for a mobile electronic device.

13. The optical system of claim 9 wherein the mounting component is configured to attach to a case of a mobile electronic device.

14. An auxiliary optical system for mounting one or more external accessories to an auxiliary optical device that is configured to attach to a mobile electronic communication device, the auxiliary optical system comprising:
a retainer component configured to removably and securely attach to a mobile electronic communication device;
an engagement portion attached to the retainer component;
one or more optical elements configured to attach to the retainer component;
an electronic auxiliary component configured to be removably and securely attached to the engagement portion.

15. The auxiliary optical system of claim 14, wherein the optical mounting component is configured to attach to a corner region of a mobile electronic communication device.

16. The auxiliary optical system of claim 14, wherein the electronic auxiliary component comprises a microphone or a flash.

17. The auxiliary optical system of claim 14, wherein the engagement portion is unitary with the retainer component.

18. The auxiliary optical system of claim 14 wherein the electronic auxiliary component is slidably attached to the engagement portion.

19. The auxiliary optical system of claim 14 wherein the one or more optical elements are removably attached to the optical mounting component.

20. The auxiliary optical system of claim 19 wherein the one or more optical elements comprise two or more optical elements with different optical features.
